(19) United States
(12) Patent Application Publication
(10) Pub. No.: US 2023/0062514 A1
(43) Pub. Date: Mar. 2, 2023

(54) Person Protection System, Method and System for Localizing a Wirelessly Communicating Object Transponder

(71) Applicant: Siemens Aktiengesellschaft, Muenchen (DE)

(72) Inventors: Reinhard Hladik, Wien (AT); Ulrike Glänzer, Neubiberg (DE); Lennart Kilian, Gauting (DE); Corina Kim Schindhelm, Gröbenzell (DE); Guido Schröer, München (DE); Joachim Wahrbichler, Graz (AT); Stefan Schwarzer, Nürnberg (DE)

(21) Appl. No.: 17/784,294

(22) PCT Filed: Dec. 4, 2020
(86) PCT No.: PCT/EP2020/084635

§ 371 Date: Jun. 10, 2022

(30) Foreign Application Priority Data
Dec. 12, 2019 (EP) 19215687

(51) Int. Cl. G01S 13/87; F16P 3/14; G01S 5/02

(52) U.S. Cl. CPC G01S 13/876; F16P 3/147; G01S 5/0244; G01S 2013/468

(57) ABSTRACT

A method for determining a protection zone with a protection radius about a wireless communication object transponder, wherein the method includes a) ascertaining a first indefinite position of the object transponder using a first locating system, b) ascertaining at least two definite anchor object distances between the object transponder and at least two anchor gateways with respective known positions via a definite distance measuring device using a two-way ranging method, and c) ascertaining the protection radius using a failsafe computing device which receives the first indefinite position from the first locating system and the at least two definite anchor object distances from the distance measuring device and determines the protection radius therefrom using the known positions of the at least two anchor gateways.

### CROSS-REFERENCE TO RELATED APPLICATIONS

This is a U.S. national stage of application No. PCT/EP2020/084635 filed 4 Dec. 2020. Priority is claimed on European Application No. 19215687.5 filed 12 Dec. 2019, the content of which is incorporated herein by reference in its entirety.

### BACKGROUND OF THE INVENTION

### 1. Field of the Invention

The invention relates to a person or object protection system, a method and a system for localizing a wirelessly communicating object transponder.

### 2. Description of the Related Art

In production systems, use is often made of protective fences for protecting persons, such as to protect operating personnel or moving objects against a moving assembly robot arm that is in operation.

However, protective fences require space in the production installation and may hamper access to installations, which is indirectly associated with production costs that adversely affect economic operation of a production system in an undesirable way.

By way of example, a virtual protective fence for dangerous production machines can be realized via a laser distance measurement or visual recognition using cameras, although this is generally very complex, inflexible and expensive.

The localization of a wirelessly communicating object transponder, i.e., the calculation of an absolute position in space (2D or 3D) via a radio-based localizing system with standard components, is deemed to be unsafe, however, in the prior art.

The calculated position can be corrupted by hardware and/or software faults of the components used or by physical effects that can be caused by the radio channel, for example.

Such effects can be caused by radio channels that are not based on a direct line of sight connection. Signal reflections can result in multipath propagation and, as a further consequence, multiple reception of the same transmission signal, but with different times of flight.

An improvement of the time-of-flight measurement can be achieved via the known two-way ranging (TWR) method. The TWR method determines the signal time of flight of the ultra-wideband (UWB) RF signal and then calculates the distance between the nodes by multiplying the time by the speed of light. The TWR process is employed between a transponder and a requested anchor (also referred to as anchor gateway or anchor transponder); only one anchor is intended to participate in the TWR at a specific point in time.

An anchor is understood to mean a stationary radio unit with a known position.

US publication 2009/310585 A1 describes a method for determining a protection zone around a wirelessly communicating transceiver, where the method is based on the conventional TOA method.

US publication 2014/038637 A1 discloses a method for determining a protection zone around a wirelessly communicating transceiver.

In both methods mentioned, however, the ascertained position data of the transceiver are not usable for safety-relevant systems since the conventional computing device used does not satisfy the stringent requirements in respect of data protection.

The publication “Information technology—Real time locating systems (RTLS)—Part 62: High rate pulse repetition frequency Ultra Wide Band (UWB) air interface”, ISO/IEC 24730-62:2013, IEC, 3, RUE DE VAREMBE, PO BOX 131, CH-1211 GENEVA 20, SWITZERLAND, Aug. 26, 2013 (2013-08-26), pages 1-57, XP082006036, describes a method where at least one anchor-object distance between a wirelessly communicating transponder and an infrastructure node with a known position is ascertained in accordance with the TWR principle via a distance measuring device, which only safeguards the data transfer against errors. However, only errors in the transfer of time stamps can be detected by this method, and a safe position is not determined in a failsafe manner suitable for safety applications.

At the present time, however, there is no known locating method with the aid of a radio system that can be used to realize safety-relevant tasks, such as dispensing with protective fences in production installations, for example, since the determination particularly of the transfer parameters of a radio channel is not reliable enough, for example, to be used in a production system and to shut down the production system in the event of undesirable encroachment and thereby to ensure the safety of persons or objects.

### SUMMARY OF THE INVENTION

In view of the foregoing, it is therefore and object of the invention to provide a method and a system for determining a protection zone around a wirelessly communicating object transponder that provides reliable and failsafe protection of persons situated in the protection zone against objects that encroach on the protection zone, with at the same time high availability of the system.

In this case, the wirelessly communicating object transponder can be carried for example by a person, i.e., the operating personnel. It should be understood an object, such as an autonomously driving vehicle, can also be equipped with an object transponder in order to protect that vehicle against a collision, for example.

The protection zone is a virtual zone which can ensure that, in the event of encroachment on this zone, a protective mechanism is activated, for example, by the encroaching object such as a robot arm being stopped directly. In other words, the protection radius of the protection zone describes that minimum radius in which the transponder is situated with safety, i.e., is reliably not situated outside.

As a result, it is possible to realize large installations without protective fences, for example, in which dangerous machines are automatically shut down if a worker equipped with an object transponder gets close enough to the machine that the protection radius intersects the dangerous region. This is expedient because only that part of the installation with the affected machine is affected by the safety measure, rather than the entire installation.

A failsafely operating computing unit (F-CPU) as a safety-certified component performs the same computation operations in each case via two independent computing devices, for example, compares the results of the operations with one another and, in the event of correspondence, provides a result deemed to be safe. A failsafely operating computing unit can execute safety-relevant and non-safety-relevant application programs and is certified up to SIL3 in accordance with to IEC 61508 and Cat4 PLd in accordance with International Organization for Standardization (ISO) standard 13849-1. IEC 61508 is a series of international standards concerning the development of electrical, electronic and programmable electronic systems which perform a safety function. It is published by the International Electrotechnical Commission (IEC) and is entitled Functional safety of safety-related electrical/electronic/programmable electronic systems.

The standard EN ISO 13849 is a safety-specific standard concerned with principles of design for safety-related parts of control systems.

These and other objects and advantages are achieved in accordance with the invention by a method in which the following steps are performed:
a) ascertaining a first, unsafe position of the object transponder via a first localizing system,
b) ascertaining at least two safe anchor-object distances between the object transponder and at least two anchor gateways with respective known positions in accordance with the two-way ranging method via a safe distance measuring device,
c) ascertaining the protection radius via a failsafe computing device, which receives the first position from the first localizing system and the at least two safe anchor-object distances from the distance measuring device and determines the protection radius therefrom with the aid of the known positions of the at least two anchor gateways.

The formation of a virtual protective fence around the transponder in the manner in accordance with the invention achieves protection of persons or objects.

It is only the combination of the use of a failsafe computing device and the corresponding choice of the place in the system at which such a failsafe computing device is intended to find application, and time stamps suitable in this context are used, that allows a reliable position determination for use in person protection systems.

While similar systems require a complex temporal synchronization of the components, for example, that can be dispensed with in accordance with the invention because the proposed method achieves a safe position determination via the expedient arrangement of the failsafe computing device and the corresponding choice of time stamps.

It should be understood the protection of the object encroaching on the protection zone, such as a production system, is also an aspect for ensuring the safety and availability of the entire installation.

Employing a protection radius ensures that only the absolutely necessary area for a protection zone is determined, as a result of which minimal impairment of the area outside the protection zone is achieved and the availability of such a system is particularly high.

In one embodiment of the invention, the minimum of the at least two anchor-object distances is determined as a minimum distance, and the respective geometric distance between an anchor gateway and the first position, and also the difference with respect to the anchor-object distances are each ascertained, and the maximum from the differences is determined as a maximum distance difference, and the protection radius is determined from the minimum distance and the maximum distance difference. As a result, it is possible even to determine a protection zone for the case with the least favorable arrangement between transponder and anchor gateways.

In another embodiment of the invention, the protection radius rₚ is determined in accordance with the relationship

rₚ=2*d_{TWRmin}+deltaₘₐₓ.

In a further embodiment of the invention, the protection radius is ascertained from the respective distance between the at least two anchor-object distances and the first position. It is thereby possible to reduce the protection radius according to the arrangement mentioned.

In another embodiment of the invention, at least one first intersection point at the distance of the respective anchor-object distance is formed around the at least two anchor gateways, and the protection radius is determined by the largest distance between the at least one first intersection point and the first position.

In yet another embodiment of the invention, the positions of three anchor gateways define a triangle area in a triangle plane, and an imaginary area normal to the triangle plane passes through the first position of the transponder, and the intersection point between the area normal and the triangle plane represents a projected transponder position that is used in the determination of the protection radius, and an ambiguity in the determination of the intersection point of the object transponder in the case of two anchor gateways is preferably resolved via a check as to whether an ascertained position of the object transponder is located within the triangle area spanned by the object transponder and the two anchor gateways.

The projected transponder position makes it possible to take account of a location of the transponder outside the triangle plane.

Furthermore, an ambiguity in the determination of the intersection point formed can be resolved by means of the safe distance in a simple manner.

In a further embodiment of the invention, the following steps are carried out:
a) acquiring transmission and reception time stamps for a respective communication message on the part of the transponder and at least two anchor gateways,
b) transferring the respective time stamps from the transponder and the at least two anchor gateways with at least one respective item of time stamp check information to a failsafe computing device, where the item of time stamp check information is preferably an item of parity information,
c) implementing at least one check via the failsafe computing device selected from:
   c1) check of the correctness of the respective time stamps based on the at least one item of time stamp check information, and
   c2) check of the calculated time duration for the processing times of the transponder and that of one anchor gateway based on known empirical values, and
d) determining the safe distance with the aid of the checked time stamps by means of the failsafe computing device, where during the acquisition of the time stamps, time stamp errors are caused only by the transponder or alternatively only by one of the at least two anchor gateways.

What is achieved thereby is that the distance to be determined is calculated failsafely because each computation operation for determining the distance is implemented in a failsafely operating computing device. The basic data, i.e., the time stamps, are acquired by the transponder and respectively the anchor gateways and the transfer of the time stamps is safeguarded by a respective item of time stamp check information. Therefore, for example, it is possible to detect an error during generation, transfer and calculation and to issue a warning that the safety of a calculation performed is not currently ensured.

In another embodiment of the invention, an indicator value for a safe distance measurement is ascertained via the failsafe computing device by way of the following relationship, which is a measure of the safety of the calculated safe distance:

$$safe\_twr \_value = \frac{( {T}_{Round 1} - {T}_{GW \_ REPLY} ) - ( {T}_{Round 2} - {T}_{TAG \_ REPLY} )}{2}$$

where

T_{Round1}=2·TOF₁+T_{GW_REPLY}

T_{Round2}=2·TOF₂+T_{TAG_REPLY}

T_{GW_REPLY}=TS_{GW_TX_RESP}−TS_{GW_RX_POLL}

T_{TAG_REPLY}=TS_{TAG_TX_FINAL}−TS_{TAG_RX_RESP}

and TOF₁ and TOF₂ are the respective signal time of flight between the transponder and one of the at least two anchor gateways.

It is thereby possible to establish in a simple manner that the time stamps were generated in a plausible manner.

In another embodiment of the invention, during the wireless communication between the object transponder and the respective anchor gateway for localization polling, a poll, a response and a final message are transmitted and received. As a result, the method in accordance with disclosed embodiments can be based on a simple and known method for two-way measuring.

In another embodiment of the invention, a process number is generated by the failsafe computing device and is transferred by the failsafe computing device with the response message.

In a further embodiment of the invention, the process number is a random number. This increases the security against manipulation because knowledge of the number is necessary in order to be able to assign the number to an anchor gateway.

In another embodiment of the invention, the item of time stamp check information is an item of parity information. This results in a technically simple implementation in which it is possible to detect errors or manipulations during the transfer of the time stamps, without the time stamps themselves being manipulated, as could occur, for example, in the case of an encryption and is at odds with the approach in accordance with embodiments of the invention that calculations are performed only by a failsafe computing device.

In a further embodiment of the invention, a communication address of the object transponder or of the at least one anchor gateway is taken into account in the calculation of the time stamp check information. This further increases the security against manipulation because an additional check of the anchor gateways known in the system can be effected.

It is also an object of the invention to provide a warning system for determining a protection zone around a wirelessly communicating object transponder, comprising a safe distance measuring device, a failsafe computing device having a memory, a localizing system and at least two anchor gateways, where the warning system is configured to perform the method in accordance with disclosed embodiments of the invention, and to determine the protection zone for the object transponder.

It is also an object of the invention to provide a protection system for a person or an object, comprising a hazardous system and a warning system in accordance with the invention with a wirelessly communicating object transponder that is carried by a person or is comprised by an object, where the protection system is configured, when the hazardous system is in operation, to initiate a process of termination of the operation of the hazardous system with the aid of the protection zone ascertained by the warning system for the object transponder for at least that part of the hazardous system whose part encroaches on the protection zone.

In one embodiment of the invention, the hazardous system is an industrial production system with movable subsystems, such as assembly robots.

In another embodiment of the invention, the protection system is provided for a vehicle, comprising a hazardous system and a warning system according to the invention with a wirelessly communicating object transponder that is comprised by the vehicle, and which vehicle carries out locomotion, where the protection system is configured to initiate a process of termination of the locomotion with the aid of the protection zone ascertained by the warning system for the object transponder of the vehicle if the hazardous system encroaches on the protection zone.

In a further embodiment of the invention, the hazardous system is a static infrastructure object, such as a building, and the object transponder is comprised by a vehicle, for example, a motor vehicle, or by a flying traffic object, for example, a helicopter or a drone for conveyance of passengers or freight.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in greater detail below on the basis of exemplary embodiments illustrated in the accompanying drawings, in which:

FIG. 1 shows an exemplary embodiment of a warning and protection system in accordance with the invention;

FIG. 2 shows an exemplary flowchart for safely determining the distance in accordance with the method of the invention;

FIG. 3 shows an exemplary poll message in accordance with the invention;

FIG. 4 shows an exemplary a TWR response message in accordance with the invention;

FIG. 5 shows an exemplary a response message in accordance with the invention;

FIG. 6 shows an exemplary TWR final message in accordance with the invention;

FIG. 7 shows an exemplary a final message in accordance with the invention;

FIG. 8 shows an exemplary arrangement in plan view with an object transponder to be localized and three gateway transponders in accordance with the invention;

FIG. 9 shows the arrangement from FIG. 8 with known distances depicted;

FIG. 10 shows an exemplary embodiment of a flow diagram of the method in accordance with the invention;

FIG. 11 shows a representation of the distances and of the associated times of flight in accordance with the example from FIG. 8,

FIG. 12 shows a representation of the geometric relationship with an exemplary calculation for the protection radius with optimum size in accordance with the invention;

FIG. 13 shows a representation of the geometric relationship with an exemplary calculation for the protection radius which is larger than necessary in accordance with the invention;

FIGS. 14-15 show further exemplary geometric relationship of distances during the determination of the protection radius in accordance with the invention;

FIG. 16 shows a sector representation around a position for FCS determination in accordance with the invention;

FIGS. 17-19 show exemplary sector representations of directions ascertained for gateways with associated distances in accordance with the invention;

FIG. 20 shows an exemplary a sector representation with an unfavorable position of the object transponder in accordance with the invention;

FIG. 21 shows an illustration of the calculated distances in accordance with the example from FIG. 20;

FIG. 22 shows an exemplary sector representation with a favorable position of the object transponder in accordance with the invention;

FIG. 23 shows an illustration of the calculated distances in accordance with the example from FIG. 22;

FIGS. 24-26 show a representation of the geometric relationship of various distances for an arrangement analogous to FIG. 20 and FIG. 21; and

FIGS. 27-29 show a representation of the geometric relationship for the protection radius for various configurations in accordance with the invention.

### DETAILED DESCRIPTION OF THE EXEMPLARY EMBODIMENTS

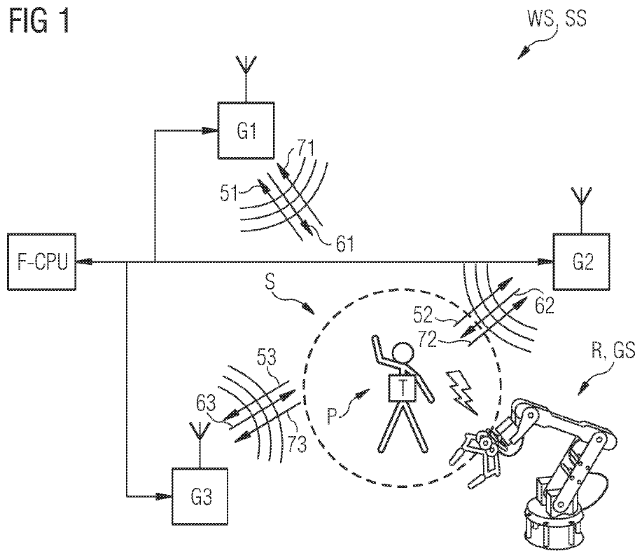

FIG. 1 illustrates an exemplary embodiment of a warning and protection system in accordance with the invention.

An object transponder or “tag” T carried, for example, by a person P wearing it on his/her body emits a respective poll signal P1-P3 comprising a poll message MP into a radio channel.

The respective poll signal P1-P3 is received from the radio channel by the respective gateway G1-G3, processed further and re-emitted as a respective response signal R1-R3 comprising a respective response message MR.

The response signals R1-R3 are received by the object transponder T, processed further and re-emitted into the radio channel as a respective final signal F1-F3 comprising the respective response message MF.

The final signals F1-F3 are received by the respective gateway G1-G3 and passed to a computing device F-CPU that effects failsafe computation, where computing device determines the protection radius rₚ of a protection zone S.

If a hazardous system in the form of a production installation, for example, is in operation, and in the course of this a robot arm R of the production installation encroaches on the protection zone S, then a termination process for the operation of the robot arm is initiated for the robot arm, as a result of which the robot arm immediately stops.

The encroachment on the protection zone S can occur, for example, by virtue of the person P getting impermissibly close to the robot arm R, and protection of the person no longer being safely ensured.

A method for determining a safe distance d_{TWR} in accordance with the TWR principle between a wirelessly communicating object transponder T and at least one anchor gateway G1-G3, each comprising acquirers for acquiring time stamps, is described below based on an exemplary embodiment of the invention.

In general, the following steps are implemented here:
a) acquiring transmission and reception time stamps TS_{TAG_TX_POLL}, TS_{GW_RX_POLL}, TS_{GW_TX_RESP}, TS_{TAG_RX_RESP}, TS_{TAG_TX_FINAL}, TS_{GW_RX_FINAL} for a respective communication message on the part of the transponder T and at least two anchor gateways G1-G3,
b) transferring the respective time stamps TS_{TAG_TX_POLL}, TS_{GW_RX_POLL}, TS_{GW_TX_RESP}, TS_{TAG_RX_RESP}, TS_{TAG_TX_FINAL}, TS_{GW_RX_FINAL} from the transponder T and the at least two anchor gateways G1-G3 with at least one respective item of time stamp check information CRC1, CRC2, for example, an item of parity information, to a failsafe computing device F-CPU,
c) implementing at least one check via the failsafe computing device F-CPU selected from:
   c1) check of the correctness of the respective time stamps TS_{TAG_TX_POLL}, TS_{GW_RX_POLL}, TS_{GW_TX_RESP}, TS_{TAG_RX_RESP}, TS_{TAG_TX_FINAL}, TS_{GW_RX_FINAL} based on the at least one item of time stamp check information CRC1, CRC2,
   c2) check of the calculated time duration for the processing times of the transponder T and that of the at least one anchor gateway G1-G3 based on known empirical values,
d) determining the safe distance d_{TWR} with the aid of the checked time stamps TS_{TAG_TX_POLL}, TS_{GW_RX_POLL}, TS_{GW_TX_RESP}, TS_{TAG_RX_RESP}, TS_{TAG_TX_FINAL}, TS_{GW_RX_FINAL} via the failsafe computing device F-CPU,
   where during the acquisition of the time stamps TS_{TAG_TX_POLL}, TS_{GW_RX_POLL}, TS_{GW_TX_RESP}, TS_{TAG_RX_RESP}, TS_{TAG_TX_FINAL}, TS_{GW_RX_FINAL} time stamp errors are caused only by the transponder T or alternatively only by one of the at least two anchor gateways G1-G3.

From this, an indicator value safe_twr_value for a safe distance measurement can be ascertained via the failsafe computing device F-CPU by way of the following relationship, which is a measure of the safety of the calculated safe distance d_{TWR}:

$$safe\_twr \_value = \frac{( {T}_{Round 1} - {T}_{GW \_ REPLY} ) - ( {T}_{Round 2} - {T}_{TAG \_ REPLY} )}{2}$$

wherein

T_{Round1}=2·TOF₁+T_{GW_REPLY}

T_{Round2}=2·TOF₂+T_{TAG_REPLY}

T_{GW_REPLY}=TS_{GW_TX_RESP}−TS_{GW_RX_POLL}

T_{TAG_REPLY}=TS_{TAG_TX_FINAL}−TS_{TAG_RX_RESP}

and TOF₁ and TOF₂ are the respective signal time of flight between the transponder T and one of the at least two anchor gateways G1-G3.

During the wireless communication between the object transponder T and the at least one anchor gateway G1-G3 for localization polling, a poll, a response and a final message MP, MR, MF are transmitted and received.

Moreover, a process number RNR can be generated by the failsafe computing device F-CPU, and is transferred with the response message MR by the failsafe computing device F-CPU. The process number RNR is a random number, for example.

Furthermore, an address of the object transponder T or of the at least one anchor gateway G1-G3 can be taken into account in the calculation of the time stamp check information CRC1, CRC2.

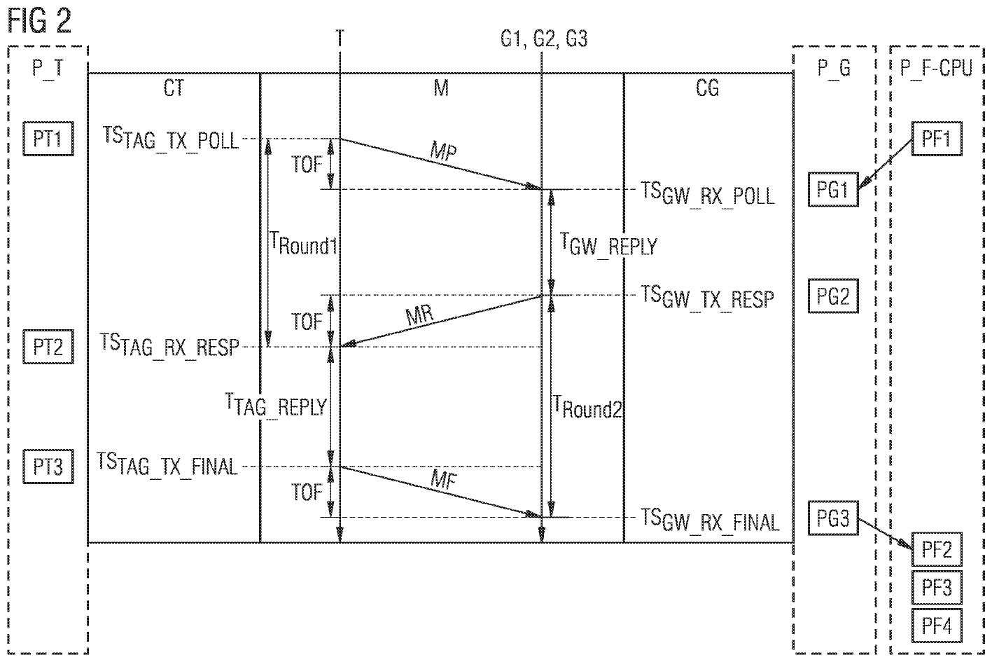

FIG. 2 illustrates an exemplary flowchart for determining the safe distance d_{TWR}, with reference to which the invention will be described in detail.

A safe distance is a distance that is ascertained without systemic errors during a time-of-flight measurement.

Undesirable influences, for example, as a result of a fluctuating or inaccurate time base, which may occur during a time of flight measurement of signals are systemically precluded by a corresponding “safe” calculation.

The position of the object transponder T (also referred to as “tag”) in a three-dimensional space is intended to be ascertained in accordance with the further explanations, reference being made to the anchor or gateway transponders G1, G2, G3 with known positions.

The poll message MP is transmitted at the transponder T or tag at a point in time with a time stamp TS_{TAG_TX_POLL} and is received at the respective anchor gateway G1-G3 at a point in time with a time stamp TS_{GW_RX_POLL}.

The transfer of the poll message MP in the radio channel between the transponder T and the respective gateway of the three gateways G1-G3 requires a duration TOF₁ (“time-of-flight”).

The poll message MP is processed by the anchor gateway within a time period T_{GW_REPLY} and a corresponding response message MR is transmitted from the anchor gateway to the transponder T at a point in time with a time stamp TS_{GW_TX_RESP} and is received at the tag at a point in time with a time stamp TS_{TAG_RX_RESP}.

The time period T_{GW_REPLY} is determined by the clock of the gateway components T_{GW_CLK} and is known within certain and known limits.

The following can thus be specified:

T_{GW_REPLY}=TS_{GW_TX_RESP}−TS_{GW_RX_POLL}

The time period T_{Round1} denotes the signal time of flight between the time stamp TS_{TAG_TX_POLL} and the time stamp TS_{TAG_RX_RESP}.

T_{Round1}=TS_{TAG_RX_RESP}−TS_{TAG_TX_POLL}

The transfer in the radio channel requires the duration TOF₂. If the transponder T was not moved, then correspondingly TOF₁=TOF₂.

The response message MR is processed by the tag within a time period T_{TAG_REPLY} and a corresponding final message MF is transmitted from the anchor gateway to the transponder T at a point in time with a time stamp TS_{TAG_TX_FINAL}.

The time period T_{TAG_REPLY} is determined by the clock of the gateway components T_{TAG_CLK} and is known within certain and known limits.

The transfer in the radio channels requires the duration TOF₃. If the transponder T was not moved, then correspondingly TOF₁=TOF₂=TOF₃.

The anchor gateway receives the final message MF at a point in time with a time stamp TS_{GW_RX_FINAL}.

The time period T_{Round2} denotes the signal time of flight between the time stamp TS_{GW_TX_RESP} and the time stamp TS_{GW_RX_FINAL}.

T_{Round2}=TS_{GW_RX_FINAL}−TS_{GW_TX_RESP}

The following can thus be specified:

T_{TAG_REPLY}=TS_{TAG_TX_FINAL}−TS_{TAG_RX_RESP}

The time stamps are acquired by a tag counter CT in the object transponder and respectively a gateway counter CG in the anchor gateway.

From the ascertained times of flight, it is possible to determine the signal time of flight in the radio channel TOF=TOF₁=TOF₂=TOF₃ and, by way of the speed of light c, the corresponding distance d_{TWR}.

$$TOF = \frac{{T}_{Round 1} \cdot {T}_{Round 2} - {T}_{GW \_ REPLY} \cdot {T}_{TAG \_ REPLY}}{{T}_{Round 1} + {T}_{Round 2} + {T}_{GW \_ REPLY} + {T}_{TAG \_ REPLY}}$$

$${d}_{TWR} = c \cdot TOF$$

The computing device F-CPU can then detect a first error if the time stamps of the transponder and of the gateways that are required for the distance calculation are falsified.

It is assumed here that only errors on the part of the transponder T or alternatively only errors on the part of one of the gateways G1-G3 occur at the same time, excluding the occurrence of errors on the part of the transponder and a gateway simultaneously.

A systemic error is understood to mean an error that unfavorably influences the generation or acquisition of time stamps, for example, an undesirably deviating time base in an electronic component, which can be caused by changing temperature, aging, component tolerances or the like. Such an error can occur between individual components in a system, such as the transponder T and a gateway G1-G3, by virtue of nonuniform variation of a local time base in the form of clock generation for a digital electronic circuit.

Time stamps or a drift of a respective timer clock in a component such as the transponder T1 or the gateways G1-G3 are independent of one another. Consequently, an error influences only the own time stamp and not that of the other components.

TWR has integrated error detection. This assumes the following relationship:

T_{Round1}=2·TOF₁+T_{GW_REPLY}

T_{Round2}=2·TOF₂+T_{TAG_REPLY}

A deviation of TOF, i.e., the difference between TOF₁ and TOF₂, as a result of errors in the transponder or in the anchor gateway can then be calculated by

$$safe\_twr \_value = \frac{( {T}_{Round 1} - {T}_{GW \_ REPLY} ) - ( {T}_{Round 2} - {T}_{TAG \_ REPLY} )}{2}$$

A TWR result is valid for safe_{twr}_{ᵥₐₗᵤₑ}<safe_twr_value_limit where safe_twr_value_limit=825 ps, otherwise the result is invalid.

The value safe_twr_value_limit=825 ps restricts a clock drift for the transponder with <±200 ppm.

The figure furthermore provides a simplified illustration of a program P_T of the transponder T with method steps PT1-PT3 for the transponder T as part of the flowchart.

Moreover, a program P_G of a respective gateway G1-G3 with method steps PG1-PG3 for the respective anchor gateway G1-G3 is discernible, as is a program P_F of the failsafely computing device F-CPU with method steps PF1-PF4 for the computing device F-CPU.

In step PT1, the poll message MP is initiated and transmitted by the transponder T.

In step PG1, the respective gateway receives the poll message MP and determines the transmission point in time for the response message MR.

In step PF1, a random number RNR is generated by the failsafely computing device F-CPU and is transmitted to the respective gateway.

In step PG2, the gateway transmits a response message MR containing the random number RNR to the transponder T.

In step PT2, the response message MR is received by the transponder T and the transmission point in time for the final message MF is calculated.

In step PT3, the transponder T determines a first checksum CRC1 from the time stamps and the address of the transponder T and the random number and transmits a final message MF containing the first checksum CRC1 from the transponder T to the gateway.

In step PG3, the gateway receives the final message MF and determines a second checksum CRC2 from the time stamps and the address of the gateway and the first checksum CRC1 and communicates the time stamps and the address of the gateway and of the transponder T and also the second checksum CRC2 to the device F-CPU.

In step PF2, the device F-CPU calculates a third checksum CRC3 and compares the third checksum CRC3 with the second checksum CRC2.

In step PF3, the device F-CPU calculates a safe value safe_twr_value for the distance between the gateway and the transponder T via the TWR method and checks the values for plausibility.

In step PF4, the device F-CPU calculates the safe distance sought on the basis of the preceding relationship with regard to the signal time of flight in the radio channel TOF.

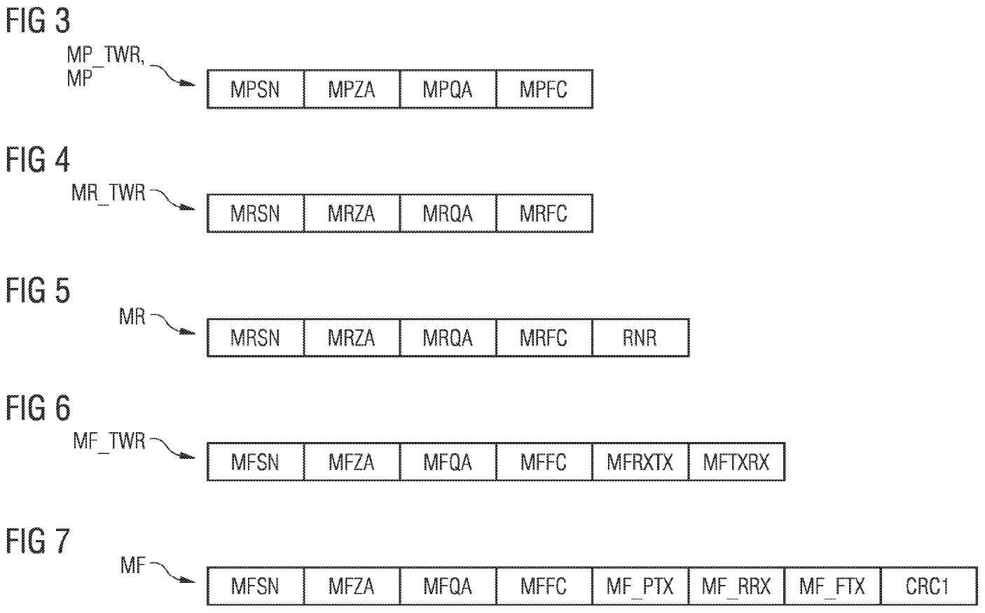

FIG. 3 illustrates by way of example a poll message MP_TWR according to the prior art for TWR, which poll message comprises data elements for a sequence number MPSN, a destination address MPZA, a source address MPQA and a function code MPFC, and can for example also be used as a poll message MP in the method according to the invention.

FIG. 4 illustrates by way of example a response message MR_TWR according to the prior art for TWR, which response message comprises data elements for a sequence number MRSN, a destination address MRZA, a source address MRQA and a function code MRFC.

FIG. 5 illustrates by way of example the response message MR according to the invention, which response message comprises data elements for a sequence number MRSN, a destination address MRZA, a source address MRQA and a function code MRFC. The function code MRFC can differ from the prior art.

The random number RNR is additionally contained.

FIG. 6 illustrates by way of example the final message MF according to the prior art for TWR, which final message comprises data elements for a sequence number MFSN, a destination address MFZA, a source address MFQA and a function code MFFC. The function code MFFC can differ from that of the prior art.

The final message MF additionally comprises a data element for a time difference MFRXTX, denoting the time duration between the transmission of the poll message MP and the reception of the response message MR on the part of the transponder T.

Moreover, the final message MF comprises a data element for a time difference MFTXRX, denoting the time duration between the reception of the response message MR and the transmission of the final message MF on the part of the transponder T.

FIG. 7 illustrates by way of example the final message MP according to the invention, which final message comprises data elements for a sequence number MPSN, a destination address MPZA, a source address MPQA and a function code MPFC. The function code MFFC can differ from that of the prior art.

The final message MP furthermore contains a respective data element in the form of a time stamp for a poll transmission point in time MF_PTX, a response reception point in time MF_RRX, and a final transmission point in time MF_FTX.

Moreover, the final message MP comprises the first checksum CRC1 formed by way of the time stamps of the transponder T and by way of the random number RNR.

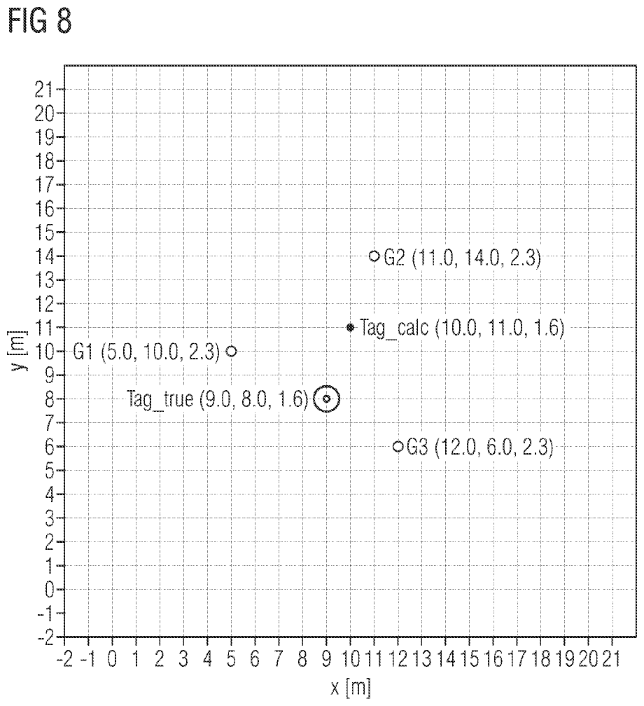

FIG. 8 shows one example of a three-dimensional arrangement with an object transponder T (also referred to as “tag”) to be localized and three anchor or gateway transponders G1, G2, G3 with known positions in a two-dimensional plan view representation.

The anchor or gateway transponders are arranged at the following coordinates:

TABLE 1
Positions of the anchor gateways

| Gateway | x-Position | y-Position | z-Position |
|---|---|---|---|
| transponder | [m] | [m] | [m] |
| G1 | 5.0 | 10.0 | 2.3 |
| G2 | 11.0 | 14.0 | 2.3 |
| G3 | 12.0 | 6.0 | 2.3 |

The gateway transponders G1-G3 are all arranged in the same plane at 2.3 m. However, it is also clear that an arrangement of the object transponders T and G1-G3 for which the further explanations can be correspondingly applied is possible in three-dimensional space as well.

In this case, it is necessary to perform a corresponding transformation via an area normal of the transponder T into that triangle plane or triangle area that is spanned by three anchor gateways G1-G3. This transformation can be disregarded, however, for small distances between the triangle plane and a transponder T spaced apart therefrom.

Conventional methods make it possible to implement a position determination of the object transponder T, for example, at the position Tag_calc (10.0,11.0,1.6), the actual position Tag_true being (9.0,8.0,1.6), in this example.

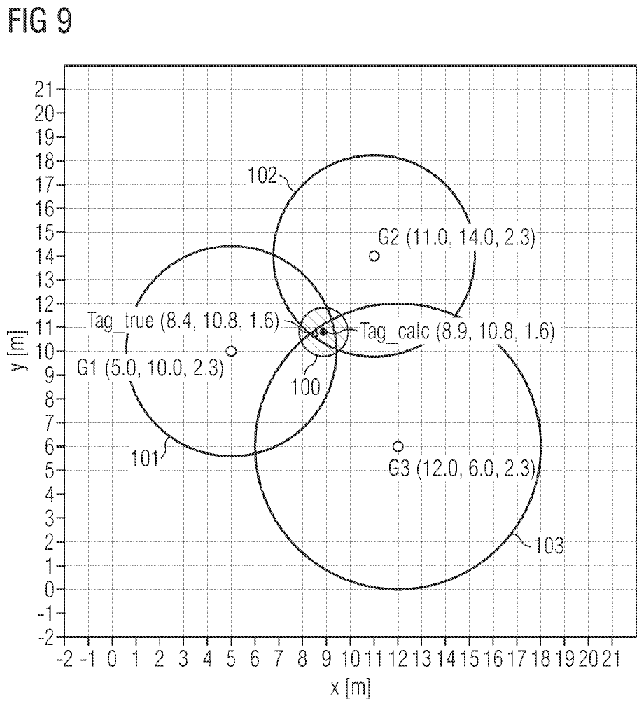

FIG. 9 shows the arrangement from FIG. 8, in which those distances that can be determined failsafely via the computing device F-CPU that effects failsafe computation are additionally depicted in the form of circles 101-103 around the position of the corresponding gateway G1-G3.

These distance measurements are subjected to a temporal latency check, for example by means of a “challenge-response” method.

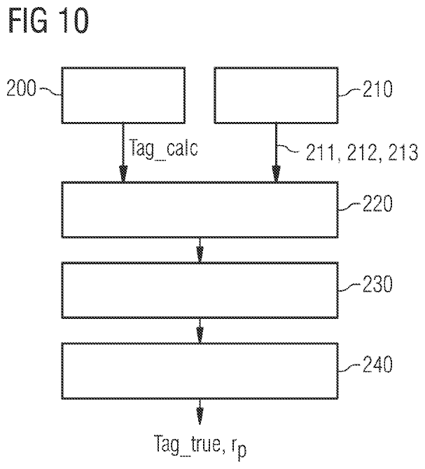

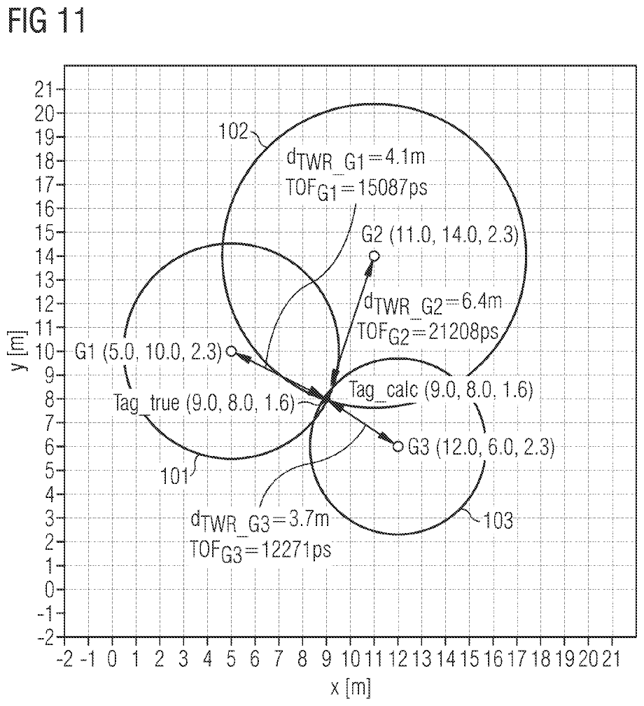

FIG. 10 shows one exemplary embodiment of a flow diagram of the method in accordance with the invention.

An independent localizing system performs an unsafe calculation 200, for example, via the TDoA method (“Time Difference of Arrival”, TDoA) and ascertains an unsafely calculated position Tag_calc at the location (x,y,z).

This calculated position can be caused, for example, by errors in the algorithm or in the underlying computing device, such as rounding errors or inaccurate calculations. Moreover, physical effects such as multipath propagation or undesirable reflections of the radio signal can lead to errors. As a result, the calculated position Tag_calc at the location (x_{calc},y_{calc}) can deviate from the actual position Tag_true at the location (xₜᵣᵤₑ,yₜᵣᵤₑ) of the object transponder T.

An incorrect position is thereby defined if the calculated position deviates from the actual position of the object transponder T by more than the specified accuracy of the localizing system. This accuracy can be approximately 30 cm, for example, in the case of an ultra-wideband-based localizing system.

Error=\sqrt{(x_{calc}−xₜᵣᵤₑ)²+(y_{calc}−yₜᵣᵤₑ)²}

The computing device F-CPU that effects failsafe computation performs a failsafe calculation 210 of distant measurements with a known latency and ascertains failsafely calculated distances 211-213.

Tuples (d_{Gn},x_{Gn},y_{Gn},Latency_{Gn}) are generated for each anchor gateway G1-G3, i.e., for n=1 . . . 3.

The unsafely calculated position 201 and the failsafely calculated distances 211-213 are checked and assessed by an ambiguity assessment 220 to the effect of whether ambiguities are possible.

A calculation 230 of a protection radius rₚ is subsequently effected. The protection radius rₚ describes a protection zone in which the object transponder T is safely situated.

In order to be able to implement the calculation of the protection radius 240, distances between the stationarily fixed anchors or gateways and the object transponder T are determined based on radio locating.

In general, the following method steps for determining a protection zone S with a protection radius rₚ around a wirelessly communicating object transponder T can be specified:
a) ascertaining a first, unsafe position Tag_calc of the object transponder T via a first localizing system,
b) ascertaining at least two, in this example three, safe anchor-object distances d_{TWR_G1}, d_{TWR_G2}, d_{TWR_G3} between the object transponder T and at least two, in this example three, anchor gateways G1-G3 with respective known positions according to the TWR principle via a safe distance measuring device,
c) ascertaining the protection radius rₚ via a failsafe computing device F-CPU, which receives the first position Tag_calc from the first localizing system and the at least two safe anchor object distances d_{TWR_G1}, d_{TWR_G2}, d_{TWR_G3} from the distance measuring device and determines the protection radius rₚ therefrom with the aid of the known positions of the at least two anchor gateways G1-G3.

Three anchor-object distances d_{TWR_G1}, d_{TWR_G2}, d_{TWR_G3} are ascertained, and the minimum thereof is determined as a minimum distance d_{TWRmin}.

Furthermore, the respective geometric distance between an anchor gateway G1-G3 and the first position Tag_calc, and also the difference with respect to the anchor-object distances are ascertained in each case, and the maximum from the differences is determined as a maximum distance difference deltaₘₐₓ.

The protection radius rₚ is determined from the minimum distance d_{TWRmin} and the maximum distance difference (deltaₘₐₓ) in accordance with the relationship

rₚ=2*d_{TWRmin}+deltaₘₐₓ.

The positions of the three anchor gateways G1-G3 define a triangle area in a triangle plane.

If the transponder T does not lie in the triangle plane, an imaginary area normal to the triangle plane passes through the first position Tag_calc of the transponder (T).

The intersection point between the area normal and the triangle plane represents a projected transponder position that is used in the determination of the protection radius rₚ.

On the basis of the geometric arrangement with respect to the unsafe position Tag_calc, an intersection point is ascertained from two of the measured anchor-object distances d_{TWR_G1}, d_{TWR_G2}, d_{TWR_G3}.

An ambiguity in the determination of the intersection point of the object transponder T in the case of two anchor gateways G1-G3 is resolved via a check as to whether an ascertained position of the object transponder T is located within the triangle area spanned by the object transponder T and the two anchor gateways G1-G3.

The ambiguity can also be resolved with the aid of a third anchor gateway.

If the area normal is placed on or outside the triangle area, then the ascertained protection radius is increased by the maximum distance difference deltaₘₐₓ.

The safe anchor-object distances d_{TWR_G1}, d_{TWR_G2}, d_{TWR_G3} between the object transponder T and an anchor gateway G1-G3 with a known position according to the TWR principle can be effected by the safe distance measuring device described above, the object transponder T and also the anchor gateway G1-G3 each comprising acquirers for acquiring time stamps.

FIG. 11 shows a representation of the distances and the associated times of flight in accordance with the example from FIG. 1, which are summarized in the table below:

TABLE 2
Distances and times of flight of the anchor gateways

| Gateway | d_{TWR}_{_{—}}_{Gn} | TOF_{_{—}}_{Gn} |
|---|---|---|
| transponder | [m] | [ps] |
| G1 | 4.1 | 15 087 |
| G2 | 6.4 | 21 208 |
| G3 | 3.7 | 12 271 |

The distances and times of flight are proportional to one another.

From the distances and times of flight, the computing device F-CPU, with the aid of geometric relationships, assesses whether ambiguities are possible and calculates the protection radius rₚ around the position Tag_calc at the location (x_{Tag_calc}, y_{Tag_calc}, z_{Tag_calc}).

$${d}_{GW \_ Tag \_ calc} = \sqrt{{( {x}_{Tag \_ calc} - {x}_{GW} )}^{2} + {( {y}_{Tag \_ calc} - {y}_{GW} )}^{2} + {( {z}_{Tag \_ calc} - {z}_{GW} )}^{2}}$$

For a safe distance between the object transponder and an anchor gateway determined without errors by means of a failsafely operating computing unit, it holds true that:

d_{TWR}=d_{Tag_calc}

With a localizing error, the following relationship holds true:

error=d_{GW_Tag_calc}−d_{TWR}

The protection radius rₚ can be increased by a correction value composed of the latency of the distance measurements and the maximally defined speed of the object transponder T.

The protection radius rₚ is determined using the two-way ranging method, which determines the time of flight of a UWB RF signal and then calculates the distance between the nodes by multiplying the time by the speed of light. The TWR process is employed between the object transponder and the requested anchor; only one anchor is permitted to participate in the TWR at a specific point in time.

The protection radius rₚ for the worst-case scenario can be determined by the F-CPU by way of the relationship

rₚ=2*d_{TWRmin}+deltaₘₐₓ

where

d_{TWRmin}=min_{n=1 . . . #gateways}d_{TWRn}

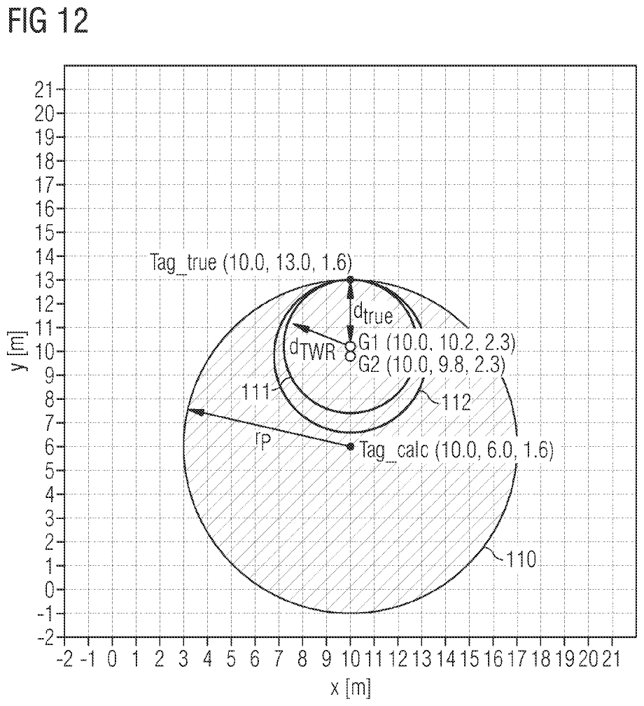

FIG. 12 illustrates the geometric relationship that is taken into account in the preceding relationship when the person transponder position calculated by the system is incorrect. The calculated protection radius rₚ covers exactly the area around the actual person transponder position Tag_true (10.0, 13.0, 1.6) that is indicated by the circle 110 around the position Tag_calc (10.0, 6.0, 1.6).

The distance dₜᵣᵤₑ corresponds to the distance between the actual person transponder position Tag_true (10.0, 13.0, 1.6) and the anchor position G1 (10.0, 10.2, 2.3).

The distance d_{TWR} corresponds to the radius of the circle 111 around the anchor position G1 used.

The circle 112 has its center point around the anchor position G2 (10.0, 9.8, 2.3) used.

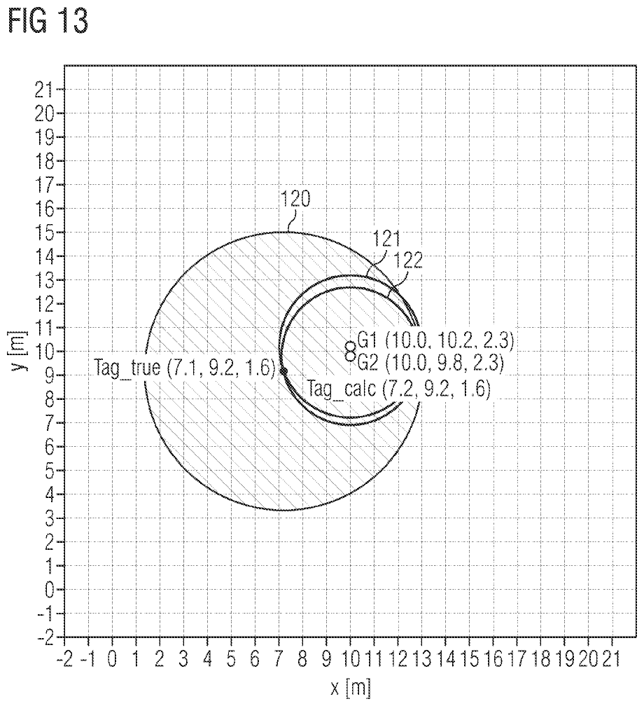

FIG. 13 illustrates the geometric relationship that is taken into account in the preceding formula when the person transponder position calculated by the system is correct. The calculated protection radius rₚ is larger than required and covers the area around the actual person transponder position which is indicated by the circle 120 around the position Tag_calc (7.2, 9.1, 1.6). The actual position Tag_true (7.1, 9.2, 1.6) lies just next to the calculated position Tag_calc.

The circle 121 has its center point around the anchor position G1 (10.0, 10.2, 2.3) used.

The circle 122 has its center point around the anchor position G2 (10.0, 9.8, 2.3) used.

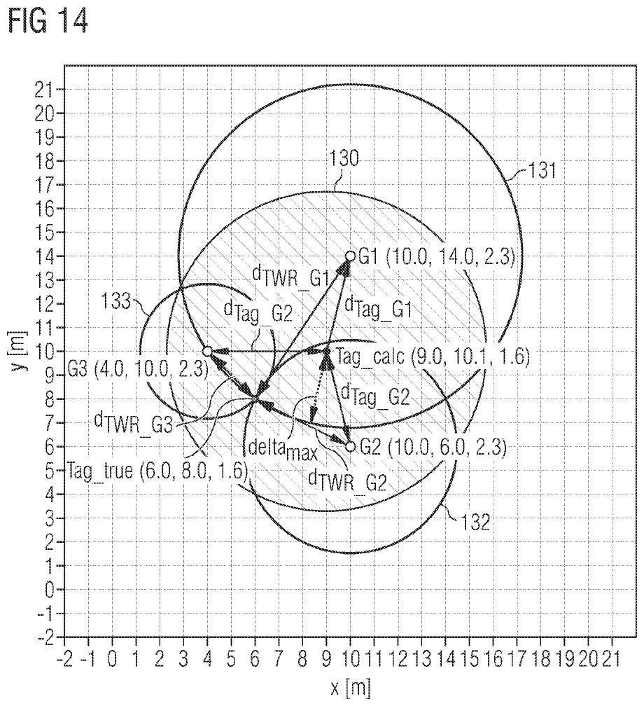

FIG. 14 shows the geometric relationship of distances in the determination of the protection radius rₚ based on one example.

Here, a maximum distance deltaₘₐₓ is calculated by the computing device F-CPU.

deltaₘₐₓ=max_{n=1 . . . #gateways}|d_{GWn_Tag_calc}−d_{GWn_TWR}|

Given an actual position Tag_true (6.0, 8.0, 1.6), gateway positions G1 (10.0, 14.0, 2.3), G2 (10.0, 6.0, 2.3) and G3 (4.0, 10.0, 2.3), and also the ascertained position Tag_calc (9.0, 10.1, 1.6), the corresponding distances can be ascertained.

delta_{G1}=delta_{Tag_G1}−d_{TWR_G1}

delta_{G2}=delta_{Tag_G2}−d_{TWR_G2}

delta_{G3}=delta_{Tag_G3}−d_{TWR_G3}

This results in the following for this example:

deltaₘₐₓ=delta_{G1}

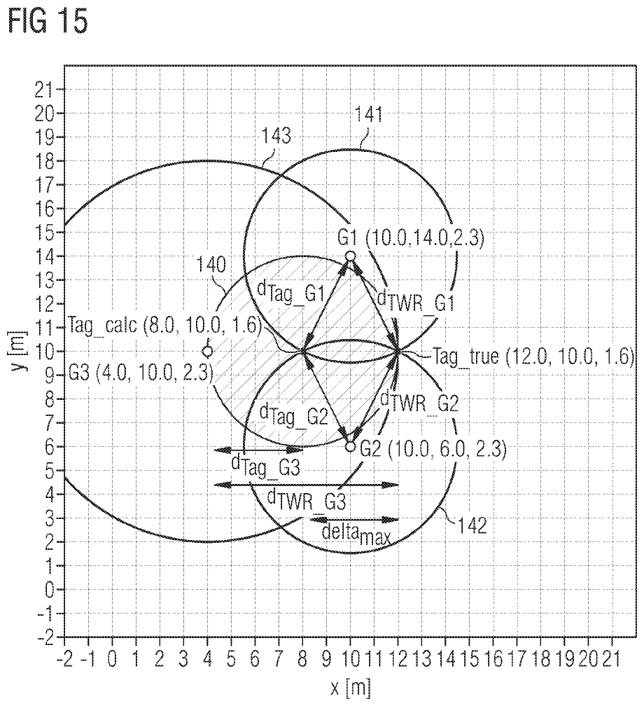

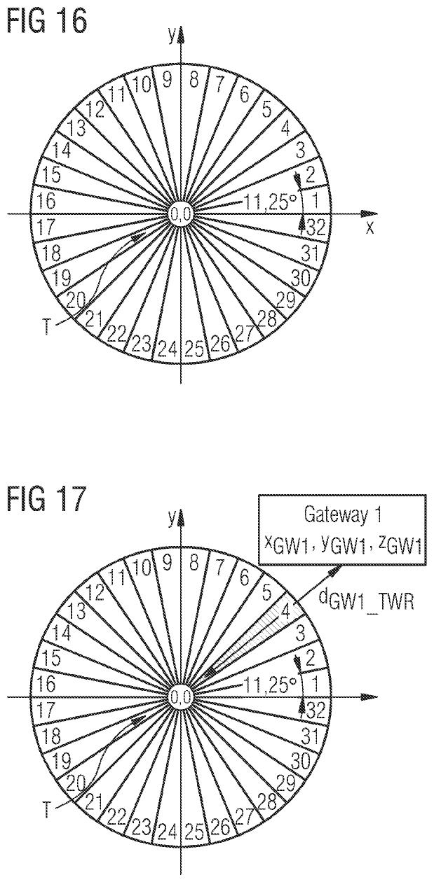

FIG. 15 shows the geometric relationship of distances in the determination of the protection radius rₚ on the basis of a further example. Here, a maximum distance deltaₘₐₓ is calculated by the computing device F-CPU.

deltaₘₐₓ=max_{n=1 . . . #gateways}|d_{GWn_Tag_calc}−d_{GWn_TWR}|

Given an actual position Tag_true (12.0, 10.0, 1.6), gateway positions G1 (10.0, 14.0, 2.3), G2 (10.0, 6.0, 2.3) and G3 (4.0, 10.0, 2.3), and also the ascertained position Tag_calc (8.0, 10.0, 1.6), the corresponding distances can be ascertained.

delta_{G1}=delta_{Tag_G1}−d_{TWR_G1}

delta_{G2}=delta_{Tag_G2}−d_{TWR_G2}

delta_{G3}=delta_{Tag_G3}−d_{TWR_G3}

This results in the following for this example:

deltaₘₐₓ=delta_{G3}

The protection radius rₚ is discernible as a circle 140.

The measured distances between the object transponder T and the gateways G1-G3 are represented as circles 141-143 around the gateways G1-G3.

FIG. 16 illustrates, on the basis of one example, sectors that can be defined around an object transponder T at the position (x_{Tag_calc}, y_{Tag_calc}, z_{Tag_calc}) as relative origin (0, 0), for example, with an angular resolution of 11.25°, whereby a circle is subdivided into 32 segments or sectors of equal size. In general, however, the number of sectors can be N.

The use of sectors is a simple method for establishing whether the transponder T is situated within the triangle spanned by the anchor gateways G1-G3. This is advantageous particularly when a cost-effective, but low-performance, failsafe computing device F-CPU is used, which may have a reduced instruction set.

The computing device F-CPU calculates a maximum free consecutive sector count FCSₘₐₓ, and also the relevant sectors that are taken into account in order to optimize the calculation of the protection radius rₚ.

The worst case for ascertaining the protection radius rₚ can lead to an unexpected switch-off as a result of side effects of UWB technology. By using those gateways that are best suited in the sense of a best possible geometry arrangement, this reduces the probability of incorrectly determined distances and directions.

The parameter FCSₘₐₓ describes the geometric situation by way of a corresponding arrangement with measured distances between different combinations of gateways and the object transponder, the determination of which necessitates determining the sectors in which the gateways are arranged.

FIG. 17 shows by way of example the direction ascertained for the gateway G1 at position (x_{GW1}, y_{GW1}, z_{GW1}) in sector 4, proceeding from the object transponder T in accordance with the preceding figure, and the associated distance d_{GW1_TWR}.

In the illustrated example, FCSₘₐₓ=31 and the geometric situation is poor.

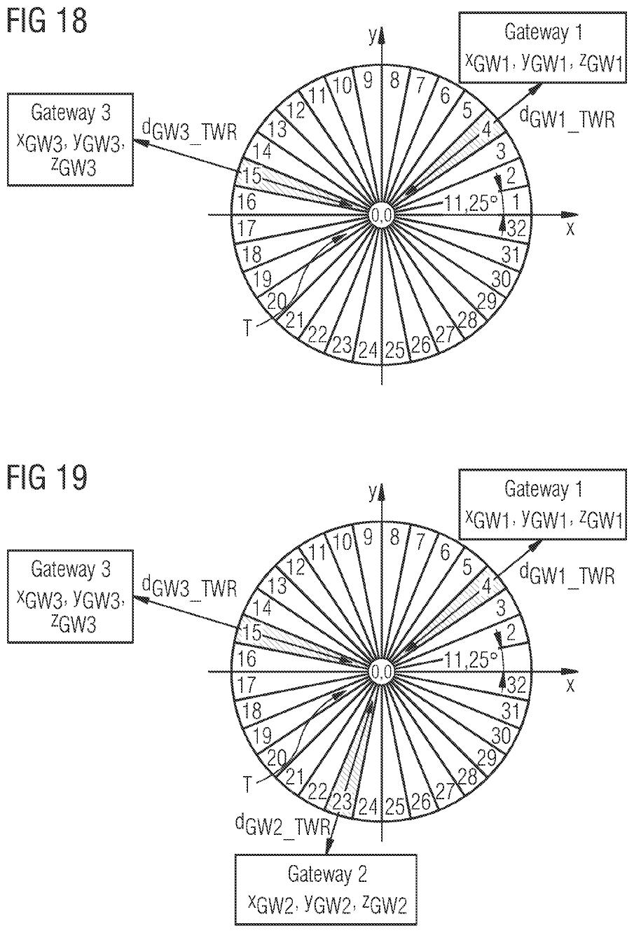

FIG. 18 supplements the preceding example by the direction ascertained for the gateway G3 at position (x_{GW3}, y_{GW3}, z_{GW3}) in segment 15, and also the associated distance d_{GW3_TWR}.

In the illustrated example, FCS_{GW1_GW3}=10 and FCS_{GW3_GW1}=20, as a result of which FCSₘₐₓ=20. The geometric situation is somewhat better than with one gateway.

FIG. 19 supplements the preceding example by the direction ascertained for the gateway G2 at position (x_{GW2}, y_{GW2}, z_{GW2}) in segment 23, and also the associated distance d_{GW2_TWR}.

In the illustrated example, FCS_{GW1_GW3}=10, FCS_{GW3_GW2}=7 and FCS_{GW2_GW1}=12, as a result of which FCSₘₐₓ=12. The geometric situation is better than with two gateways.

Those gateways which define FCSₘₐₓ are used for calculating the protection radius rₚ.

In this example, the gateways G1 and G2 define FCSₘₐₓ.

Δx_{GWn}=x_{GWn}−x_{Tag calc}

Δy_{GWn}=y_{GWn}−y_{Tag_calc}

The parameters x_{GWn} and x_{Tag_calc} are not used in the sector determination.

The protection radius rₚ can then be calculated by the computing device F-CPU for
FCSₘₐₓ≥N/2, in this example FCSₘₐₓ≥16 in the case of 32 segments, i.e., 180°
   in accordance with the relationship:

rₚ=\sqrt{y_{diff}²+(h_{TWR}+h_{Tag_calc})²}.

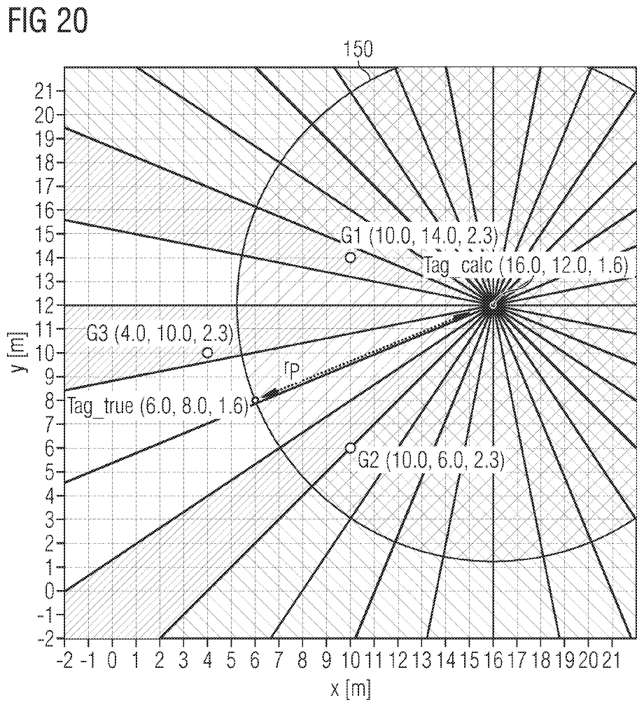

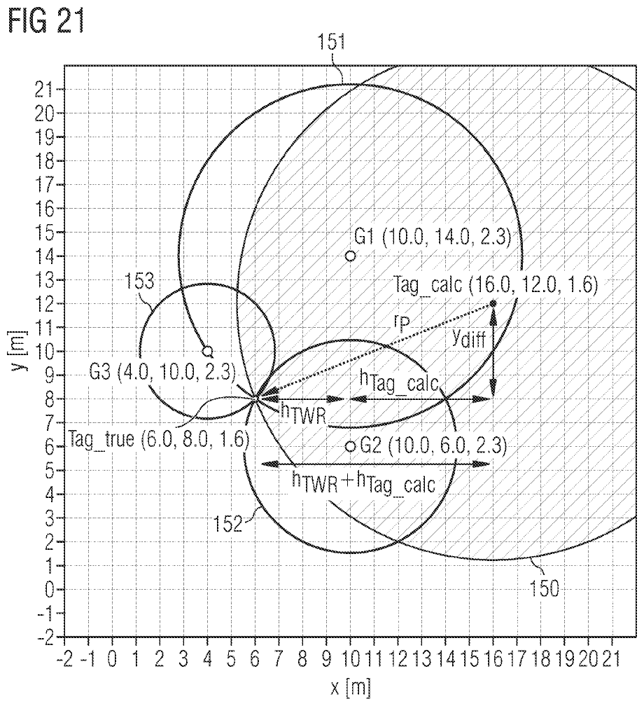

FIG. 20 shows the object transponder T at the calculated position Tag_calc (16.0, 12.0, 1.6) and at the actual position (6.0, 8.0, 1.6), and also the gateway G1 at the position (10.0, 14.0, 2.3), the gateway G2 at the position (10.0, 6.0, 2.3) and the gateway G3 at the position (4.0, 10.0, 2.3) in a configuration that leads to an FCSₘₐₓ=26. Here, all the gateways G1-G3 are arranged to the left of the object transponder T, which results in a poor geometric situation of the distances between the object transponder T and the gateways G1-G3.

The protection radius rₚ is discernible as a circle 150.

FIG. 21 illustrates the geometric relationship from the preceding formula. The measured distances between the object transponder T and the gateways G1-G3 are represented as circles 151-153 around the gateways G1-G3, which lead to an intersection point in relation to the actual object transponder position Tag_true.

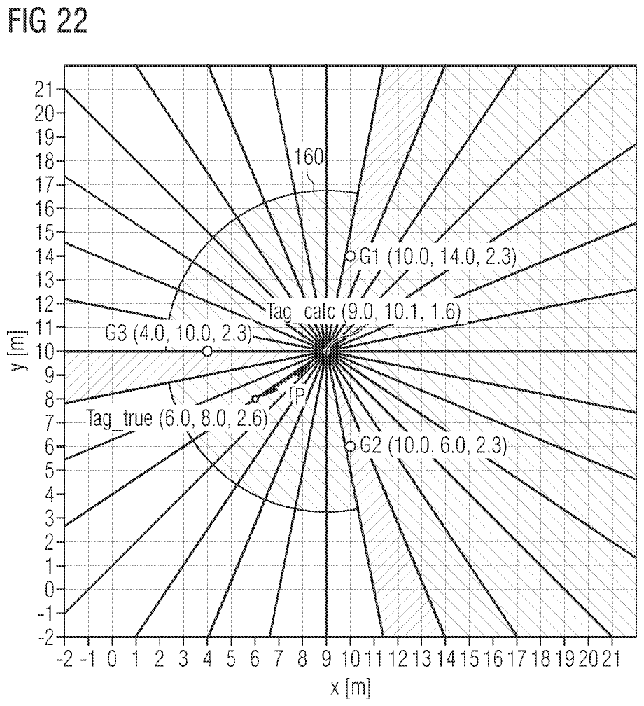

FIG. 22 shows an arrangement with an object transponder T arranged approximately centrally between the gateways G1-G3, which results in a favorable geometric situation of the distances between the object transponder T and the gateways G1-G3.

The figure shows the object transponder T at the calculated position Tag_calc (9.0, 10.2, 1.6) and at the actual position Tag_true (6.0, 8.0, 2.6), and also the gateway G1 at the position (10.0, 14.0, 2.3), the gateway G2 at the position (10.0, 6.0, 2.3) and the gateway G3 at the position (4.0, 10.0, 2.3).

The configuration chosen in this example leads to an FCSₘₐₓ=12.

In contrast to the previously mentioned relationship, the protection radius rₚ can be calculated by the computing device F-CPU for
FCSₘₐₓ<N/2, in this example FCSₘₐₓ<16 in the case of 32 segments, i.e. 180°, and also

h_{Tag_calc}·0.7<deltaₘₐₓ

but in accordance with the relationship:

rₚ=\sqrt{y_{diff}²+(h_{TWR}+h_{Tag_calc})²}+deltaₘₐₓ.

The protection radius rₚ is discernible as a circle 160.

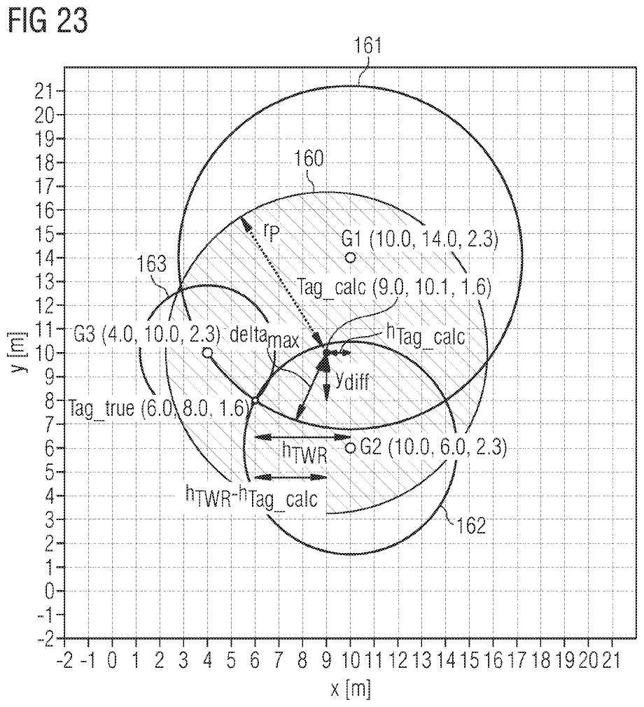

FIG. 23 illustrates the geometric relationship according to the preceding formula. The measured distances between the object transponder T and the gateways G1-G3 are represented as circles 161-163 around the gateways G1-G3, which lead to an intersection point in relation to the actual object transponder position Tag_true.

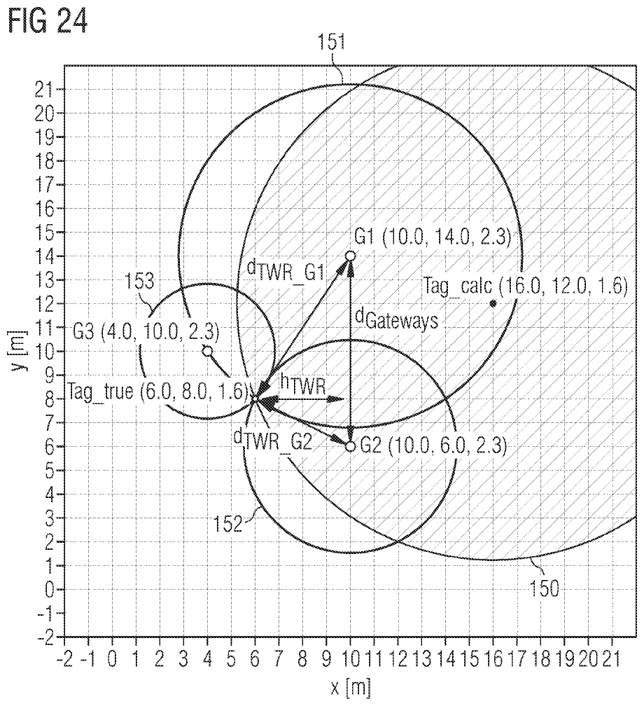

FIG. 24 illustrates the geometric relationship for distances of an arrangement analogous to FIG. 18 and FIG. 19.

In this case, the computing device F-CPU calculates the distances h_{TWR} and h_{Tag_calc} in accordance with the mathematical relationships:

$${d}_{Gateways} = \sqrt{{( {x}_{G 1} - {x}_{G 2} )}^{2} + {( {y}_{G 1} - {y}_{G 2} )}^{2}}$$

$${h}_{TWR} = {d}_{TWR \_ G 1}^{2} - \frac{{( {d}_{Gateways}^{2} - {d}_{{TWR}_{G 2}}^{2} + {d}_{{TWR}_{G 1}}^{2} )}^{2}}{4 \cdot {d}_{Gateways}^{2}}$$

The following therefore arises in this example:

$${d}_{Tag G 1} = \sqrt{{( {x}_{G 1} - {x}_{Tag calc} )}^{2} + {( {y}_{G 1} - {y}_{Tag calc} )}^{2}}$$

$${d}_{Tag\_G 2} = \sqrt{{( {x}_{G 2} - {x}_{Tag \_ calc} )}^{2} + {( {y}_{G 2} - {y}_{Tag \_ calc} )}^{2}}$$

$${h}_{Tag \_ calc} = {d}_{Tag \_ G 1}^{2} - \frac{{( {d}_{Gateways}^{2} - {d}_{{Tag}_{G 2}}^{2} + {d}_{{Tag}_{G 1}}^{2} )}^{2}}{4 \cdot {d}_{Gateways}^{2}}$$

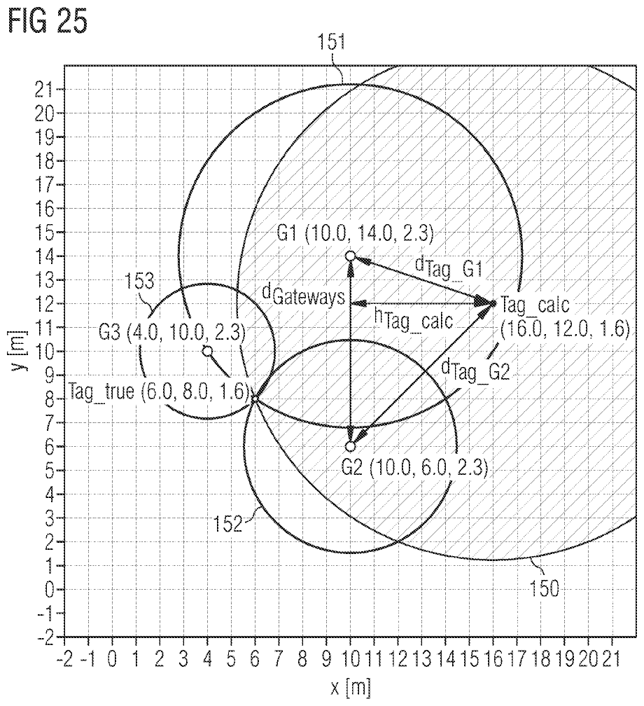

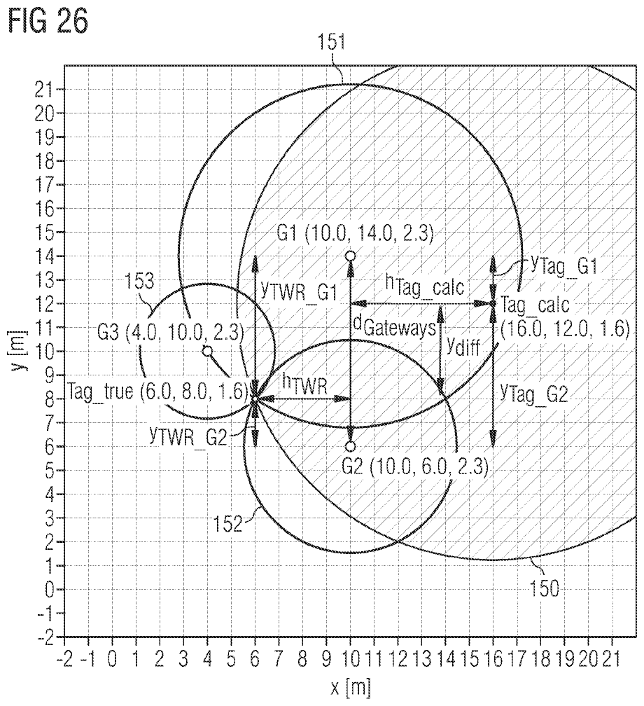

FIG. 25 illustrates the geometric relationship for the abovementioned formula for determining the distance h_{Tag_calc}. FIG. 26 illustrates the geometric relationship for the distance y_{diff}, which is determined by the computing device F-CPU.

The gateways are arranged at the positions G1 (10.0, 14.0, 2.3), G2 (10.0, 6.0, 2.3) and G3 (4.0, 10.0, 2.3).

The object transponder is arranged at the actual position Tag_true (6.0, 8.0, 1.6) and the ascertained position Tag_calc (16.0, 12.0, 1.6).

The following mathematical relationships are determined for this purpose:

d_{Gateways}=\sqrt{(x_{G1}−x_{G2})²+(y_{G1}−y_{G2})²}

y_{Tag_G1}={square root over ((d_{Tag_G1}²−h_{Tag_calc}²)}

y_{Tag_G1}={square root over ((d_{Tag_G2}²−h_{Tag_calc}²)}

y_{TWR_G1}={square root over ((d_{TWR_G1}²−h_{TWR}²)}

y_{TWR_G2}={square root over ((d_{TWR_G2}²−h_{TWR}²)}

As long as all the following conditions are true:

y_{TWR_G1}<d_{Gateways}

y_{TWR_G2}<d_{Gateways}

y_{Tag_G1}<d_{Gateways}

y_{Tag_G2}<d_{Gateways}

The following relationship holds true:

y_{diff}=y_{TWR_G1}−y_{Tag_G1}

Otherwise, the protection radius rₚ is determined by:

rₚ=2*d_{TWR}+deltaₘₐₓ

The figure illustrates the geometric relationship for the distance y_{diff} if

y_{Tag_G2}>d_{Gateways}

y_{TWR_G2}>d_{Gateways}

The protection radius rₚ is discernible as a circle 150.

The measured distances between the object transponder T and the gateways G1-G3 are represented as circles 151-153 around the gateways G1-G3.

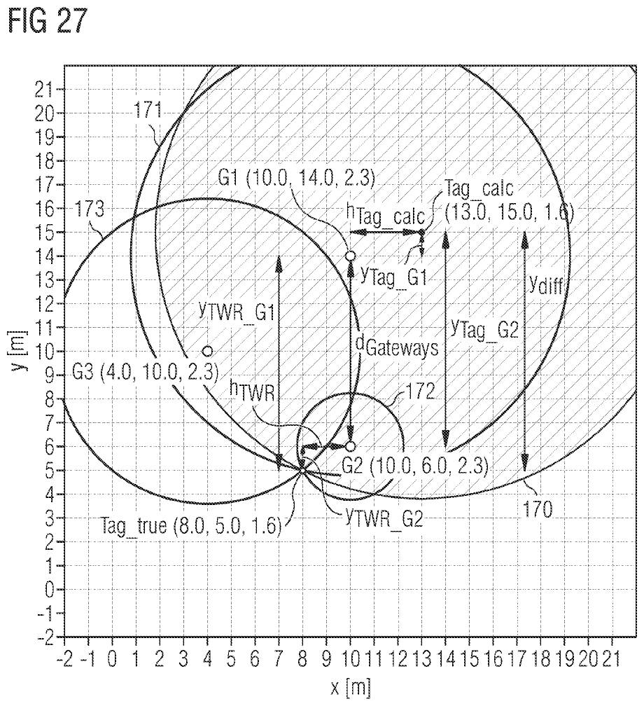

FIG. 27 illustrates, for the arrangement from the preceding figure, the geometric relationship for the protection radius rₚ if

y_{Tag_G2}>d_{Gateways}

y_{TWR_G1}>d_{Gateways}

The protection radius rₚ is discernible as a circle 170.

The measured distances between the object transponder T and the gateways G1-G3 are represented as circles 171-173 around the gateways G1-G3.

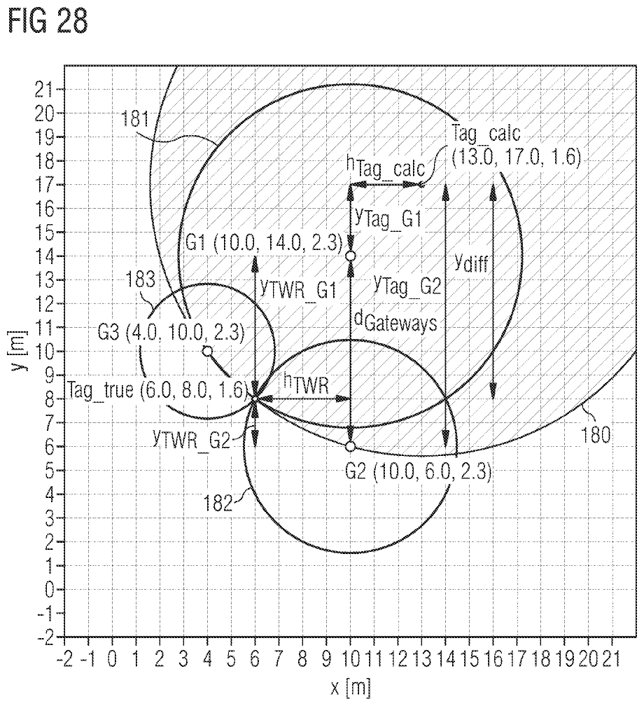

FIG. 28 illustrates the geometric relationship for the protection radius r if

y_{Tag_G2}>d_{Gateways}

y_{TWR_G2}<d_{Gateways}

The protection radius rₚ is discernible as a circle 180.

The measured distances between the object transponder T and the gateways G1-G3 are represented as circles 181-183 around the gateways G1-G3.

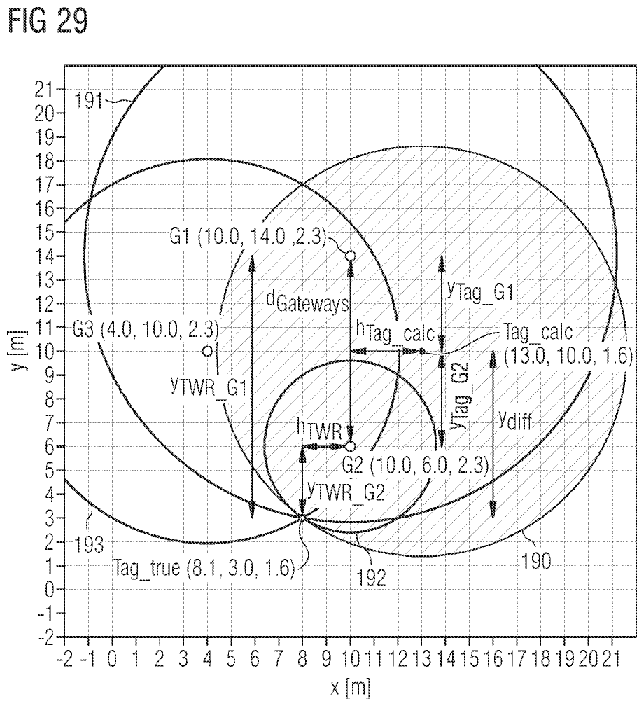

FIG. 29 illustrates the geometric relationship for the protection radius rₚ if

y_{Tag_G2}<d_{Gateways}

y_{TWR_G1}<d_{Gateways}

The protection radius rₚ is discernible as a circle 190.

The measured distances between the object transponder T and the gateways G1-G3 are represented as circles 191-193 around the gateways G1-G3.

The computing device F-CPU can then correct the protection radius rₚ in accordance with the following relationship:

rₚ′=rₚv_{maxTag}·Δt

Where Δt is the time difference with respect to the last successful implementation of latency monitoring, and also the safe calculation of distance and protection radius rₚ.

By way of example, the person P who is carrying the object transponder T by wearing it may move at a speed of v_{maxTag} if the two-way data acquisition is effected, for example, every 400 ms or preferably every 100 ms. Here, the protection radius rₚ is possibly not large enough to cover the position of the object transponder T.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-16. (canceled)

17. A method for determining a protection zone (S) with a protection radius (rₚ) around a wirelessly communicating object transponder (T), the method comprising:
a) ascertaining a first unsafe position (Tag_calc) of the object transponder (T) via a first localizing system;
b) ascertaining at least two safe anchor-object distances (d_{TWR_G1}, d_{TWR_G2}, d_{TWR_G3}) between the object transponder (T) and at least two anchor gateways (G1-G3) with respective known positions in accordance with a two-way ranging method via a safe distance measuring device;
c) ascertaining the protection radius (rₚ) via a failsafe computing device (F-CPU) which receives the first unsafe position (Tag_calc) from the first localizing system and the at least two safe anchor-object distances (d_{TWR_G1}, d_{TWR_G2}, d_{TWR_G3}) from the distance measuring device and which determines the protection radius (rₚ) therefrom aided by the respective known positions of the at least two anchor gateways (G1-G3).

18. The method as claimed in the claim 17, wherein a minimum of the at least two anchor-object distances (d_{TWR_G1}, d_{TWR_G2}, d_{TWR_G3}) is determined as a minimum distance (d_{TWRmin});
wherein a respective geometric distance between an anchor gateway (G1-G3) and the first unsafe position (Tag_calc), and also a difference with respect to the anchor-object distances are each ascertained, and a maximum from the differences is determined as a maximum distance difference (deltaₘₐₓ); and
wherein the protection radius (rₚ) is determined from the minimum distance (d_{TWRmin}) and the maximum distance difference (deltaₘₐₓ).

19. The method as claimed in claim 17, wherein the protection radius (rₚ) is determined in accordance with the relationship:
rₚ=2*d_{TWRmin}+deltaₘₐₓ

20. The method as claimed in claim 17, wherein the protection radius (rₚ) is ascertained from the respective distance between the at least two anchor-object distances (d_{TWR_G1}, d_{TWR_G2}, d_{TWR_G3}) and the first position (Tag_calc).

21. The method as claimed in claim 17, wherein at least one first intersection point at a distance of the respective anchor-object distance (d_{TWR_G1}, d_{TWR_G2}, d_{TWR_G3}) is formed around the at least two anchor gateways (G1-G3); and
wherein the protection radius (rₚ) is determined by a largest distance between the at least one first intersection point and the first unsafe position (Tag_calc).

22. The method as claimed in claim 17, wherein positions of three anchor gateways (G1-G3) define a triangle area in a triangle plane, and an imaginary area normal to the triangle plane passes through the first unsafe position (Tag_calc) of the transponder (T), and an intersection point between the imaginary area normal and the triangle plane represents a projected transponder position which is utilized to determine the protection radius (rₚ).

23. The method as claimed in claim 17, wherein the at least two safe anchor-object distances (d_{TWR_G1}, d_{TWR_G2}, d_{TWR_G3}) between the object transponder (T) and two anchor gateways of the at least two anchor gateways (G1-G3) with known positions are ascertained in accordance with the two-way ranging method via a safe distance measuring device;
wherein the object transponder (T) and also at least two anchor gateways (G1-G3) each comprise time stamp acquirers, the method further comprising:
d) acquiring transmission and reception time stamps (TS_{TAG_TX_POLL}, TS_{GW_RX_POLL}, TS_{GW_TX_RESP}, TS_{TAG_RX_RESP}, TS_{TAG_TX_FINAL}, TS_{GW_RX_FINAL}) for a respective communication message on a part of the transponder (T) and the at least two anchor gateways (G1-G3),
e) transferring respective time stamps (TS_{TAG_TX_POLL}, TS_{GW_RX_POLL}, TS_{GW_TX_RESP}, TS_{TAG_RX_RESP}, TS_{TAG_TX_FINAL}, TS_{GW_RX_FINAL}) from the transponder (T) and the at least two anchor gateways (G1-G3) with at least one respective item of time stamp check information (CRC1, CRC2) to a failsafe computing device (F-CPU), the item of time stamp check information (CRC1, CRC2) being an item of parity information;
f) implementing at least one check via the failsafe computing device (F-CPU) selected from:
f1) a check of a correctness of the respective time stamps (TS_{TAG_TX_POLL}, TS_{GW_RX_POLL}, TS_{GW_TX_RESP}, TS_{TAG_RX_RESP}, TS_{TAG_TX_FINAL}, TS_{GW_RX_FINAL}) based on the at least one item of time stamp check information (CRC1, CRC2), and
f2) a check of the calculated time duration for the processing times of the transponder (T) and that of one anchor gateway (G1-G3) based on known empirical values;
g) determining the safe distance (d_{TWR}) with the aid of the checked time stamps (TS_{TAG_TX_POLL}, TS_{GW_RX_POLL}, TS_{GW_TX_RESP}, TS_{TAG_RX_RESP}, TS_{TAG_TX_FINAL}, TS_{GW_RX_FINAL}) by means of the failsafe computing device (F-CPU);
wherein during acquisition of the time stamps (TS_{TAG_TX_POLL}, TS_{GW_RX_POLL}, TS_{GW_TX_RESP}, TS_{TAG_RX_RESP}, TS_{TAG_TX_FINAL}, TS_{GW_RX_FINAL}), time stamp errors are caused only by the transponder (T) or only by one anchor gateway of the at least two anchor gateways (G1-G3); and
wherein during the wireless communication between the object transponder (T) and the at least one anchor gateway (G1-G3) for localization polling, a poll, a response and a final message (MP, MR, MF) are transmitted and received.

24. The method as claimed in claim 17, wherein an indicator value (safe_twr_value) for a safe distance measurement is ascertained via the failsafe computing device (F-CPU) in accordance with the following relationship, which comprises a measure of a safety of the calculated safe distance (d_{TWR}):
$$safe\_twr \_value = \frac{( {T}_{Round 1} - {T}_{GW \_ REPLY} ) - ( {T}_{Round 2} - {T}_{TAG \_ REPLY} )}{2} ;$$
wherein
T_{Round1}=2·TOF₁+T_{GW_REPLY}
T_{Round2}=2·TOF₂+T_{TAG_REPLY}
T_{GW_REPLY}=TS_{GW_TX_RESP}−TS_{GW_RX_POLL}
T_{TAG_REPLY}=TS_{TAG_TX_FINAL}−TS_{TAG_RX_RESP}
and TOF₁ and TOF₂ are respective signal times of flight between the transponder (T) and one anchor gateway of the at least two anchor gateways (G1-G3); and
wherein time stamps TS_{TAG_TX_POLL}, TS_{TAG_RX_RESP}, TS_{TAG_TX_FINAL} are acquired by the transponder (T), and time stamps TS_{GW_RX_POLL}, TS_{GW_TX_RESP}, TS_{GW_RX_FINAL} are acquired by the anchor gateway of the at least two anchor gateways (G1-G3).

25. The method as claimed in claim 23, wherein a process number (RNR) is generated by the failsafe computing device (F-CPU) and is transferred by the latter with the response message (MR), the process number (RNR) comprising a random number.

26. The method as claimed in claim 24, wherein a process number (RNR) is generated by the failsafe computing device (F-CPU) and is transferred by the latter with the response message (MR), the process number (RNR) comprising a random number.

27. The method as claimed in claim 23, wherein a communication address of one of the object transponder (T) and the at least one anchor gateway (G1-G3) is taken into account during calculation of the time stamp check information (CRC1, CRC2).

28. The method as claimed in claim 24, wherein a communication address of one of the object transponder (T) and the at least one anchor gateway (G1-G3) is taken into account during calculation of the time stamp check information (CRC1, CRC2).

29. The method as claimed in claim 25, wherein a communication address of one of the object transponder (T) and the at least one anchor gateway (G1-G3) is taken into account during calculation of the time stamp check information (CRC1, CRC2).

30. A warning system for determining a protection zone (S) around a wirelessly communicating object transponder (T), comprising:
a safe distance measuring device;
a failsafe computing device (F-CPU) having a memory;
a localizing system; and
at least two anchor gateways (G1-G3);
wherein the warning system (WS) is configured to:
a) ascertain a first unsafe position (Tag_calc) of the object transponder (T) via a first localizing system;
b) ascertain at least two safe anchor-object distances (d_{TWR_G1}, d_{TWR_G2}, d_{TWR_G3}) between an object transponder (T) and the at least two anchor gateways (G1-G3) with respective known positions in accordance with a two-way ranging method via the safe distance measuring device; and
c) ascertain the protection radius (rₚ) via the failsafe computing device (F-CPU) which receives the first unsafe position (Tag_calc) from the first localizing system and the at least two safe anchor-object distances (d_{TWR_G1}, d_{TWR_G2}, d_{TWR_G3}) from the distance measuring device and which determines the protection radius (rₚ) therefrom aided by the respective known positions of the at least two anchor gateways (G1-G3); and
wherein the warning system (WS) is configured to determine the protection zone (S) for the object transponder (T).

31. A protection system (SS) for a person or an object, comprising a hazardous system (GS) and a warning system (WS) as claimed in claim 17 with a wirelessly communicating object transponder (T) which is carried by a person (P) or is comprised by an object;
wherein the protection system (SS) is configured, when the hazardous system (GS) is in operation, to initiate a process of termination of operation of the hazardous system (GS) aided by the protection zone (S) ascertained by the warning system (WS) for the object transponder (T) for at least that part of the hazardous system (GS) whose part encroaches on the protection zone (S).

32. The protection system (SS) as claimed in the claim 31, wherein the hazardous system (GS) comprises an industrial production system with movable subsystems

33. The protection system (SS) as claimed in claim 32, wherein the movable subsystems comprise assembly robots (R).

34. A protection system (SS) for a vehicle, comprising a hazardous system and a warning system (WS) as claimed in claim 30 with a wirelessly communicating object transponder (T) which is comprised by the vehicle which implements locomotion;
wherein the protection system (SS) is configured to initiate a process of termination of the locomotion aided by the protection zone (S) ascertained by the warning system (WS) for the object transponder (T) of the vehicle when the hazardous system (GS) encroaches on the protection zone (S).

35. The protection system (SS) as claimed in claim 34, wherein the hazardous system (GS) comprises a static infrastructure object, and wherein the object transponder (T) comprises a vehicle or a flying traffic object.

36. The protection system (SS) as claimed in claim 34, wherein the static infrastructure object comprises a building; wherein the vehicle comprises a motor vehicle, and wherein the flying object comprises one of an helicopter and a drone for conveyance of passengers or freight.
